(19) United States
(12) Patent Application Publication
(10) Pub. No.: US 2025/0135587 A1
(43) Pub. Date: May 1, 2025

(54) INTELLIGENT AUTOMATED MULTI-PASS WELDING METHOD

(71) Applicants: NATIONAL APPLIED RESEARCH LABORATORIES, Taipei City (TW); Evergreen Steel Corporation, Taipei City (TW); Chun Yuan Steel Industry Co., Ltd., Taipei City (TW); Tung Kang Steel Structure Corporation, Taipei City (TW); China Steel Structure Co., Ltd., Kaohsiung City (TW)

(72) Inventors: Chung-Che CHOU, Taipei City (TW); Wei-Tze CHANG, Taipei City (TW); Gee-Jin YU, Taipei City (TW); Kung-Juin WANG, Taipei City (TW); Chiun-Lin WU, Taipei City (TW); Chun-Yao YANG, Taipei City (TW)

(21) Appl. No.: 18/918,301

(22) Filed: Oct. 17, 2024

(30) Foreign Application Priority Data
Oct. 25, 2023 (TW) 112140751

(51) Int. Cl. B23K 31/12; B23K 31/00; B23K 31/02; B23K 37/02

(52) U.S. Cl. CPC B23K 31/125; B23K 31/006; B23K 31/02; B23K 37/0252

(57) ABSTRACT

An automated multi-pass welding method is provided. An optical measuring instrument measures a welding space to obtain reference geometry information, and then the reference geometry information is inputted into an AI model to obtain control parameters that are used by a welding device and a robotic arm as operation settings to perform welding. The optical measuring instrument measures the welding space after the welding to obtain post-welding geometry information for a computerized control device to generate a classification result. When the computerized control device determines to form a next weld pass based on the classification result, the aforesaid actions are repeated until the computerized control device determines to stop welding.

### CROSS-REFERENCE TO RELATED APPLICATION

This application claims priority to Taiwanese Invention patent application No. 112140751, filed on Oct. 25, 2023, the entire disclosure of which is incorporated by reference herein.

### FIELD

The disclosure relates to a welding method, and more particularly to an intelligent automated multi-pass welding method.

### BACKGROUND

Nowadays, the steel construction industry is facing a generational shift in expertise causing a shortage of skilled welders. As a result, the industry has partially adopted semi-automated methods to reduce the demand for welders. However, in the manufacturing of multi-pass (or multi-layer) welded steel structures, manual welding is still predominantly used due to the inability of automation to overcome the complex effects of geometric tolerances, steel plate deformation, assembly errors, and the interdependence of welding parameters. Although academic research has developed some techniques using depth cameras or LiDARs to identify weld passes, the massive amount of data thus generated has limited production efficiency, making these methods less attractive to the industry. Therefore, finding a more automated welding method for multi-pass weld steel structures remains an unresolved challenge.

### SUMMARY

Therefore, an object of the disclosure is to provide a welding method for multi-pass weld steel structure, which utilizes artificial intelligence (AI) technology.

According to the disclosure, an automated multi-pass welding method is provided to include steps of: (A) by an optical measuring instrument, measuring a welding space formed by two steel components that is in contact with each other, thereby obtaining reference geometry information of the welding space; (B) by a computerized control device, inputting the reference geometry information of the welding space into a first artificial intelligence (AI) model, thereby obtaining control parameters of a welding device and a robotic arm, where the welding device is to be used for welding, and the robotic arm is used to operate the welding device; (C) by the welding device and the robotic arm, using the control parameters as operation settings thereof to cause the welding device to work with a welding wire feeder to perform welding on the welding space, thereby forming a weld pass in the welding space; (D) by the optical measuring instrument, measuring the welding space after the weld pass is formed in the welding space, thereby obtaining a post-welding geometry information of the welding space; (E) by the computerized control device, generating a classification result based on the post-welding geometry information of the welding space; and (F) by the computerized control device, upon determining, based on the classification result, to form a next weld pass in the welding space, repeating steps B) to F) with the post-welding geometry information of the welding space serving as the reference geometry information of the welding space, until the computerized control device determines to stop welding based on the classification result.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an exemplary system to implement an embodiment of an intelligent automated multi-pass welding method according to the disclosure.

FIG. 2 is a perspective view illustrating actual use of the exemplary system.

FIG. 3 is a fragmentary sectional view illustrating a welding space in accordance with some embodiments.

FIG. 4 is a flow chart illustrating steps of the embodiment of the intelligent automated multi-pass welding method according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

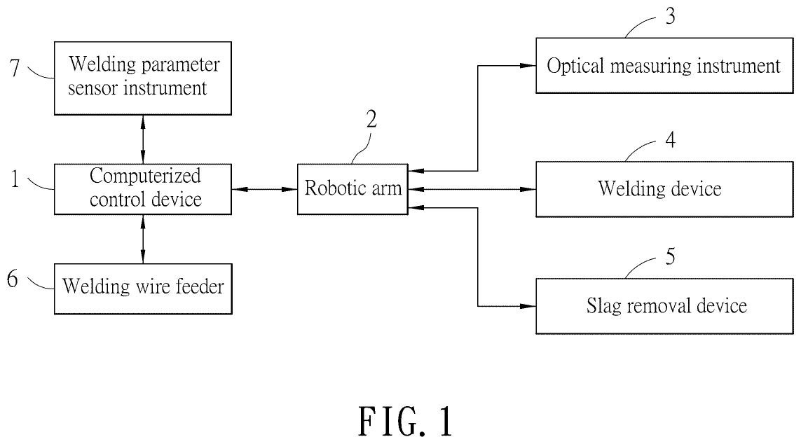

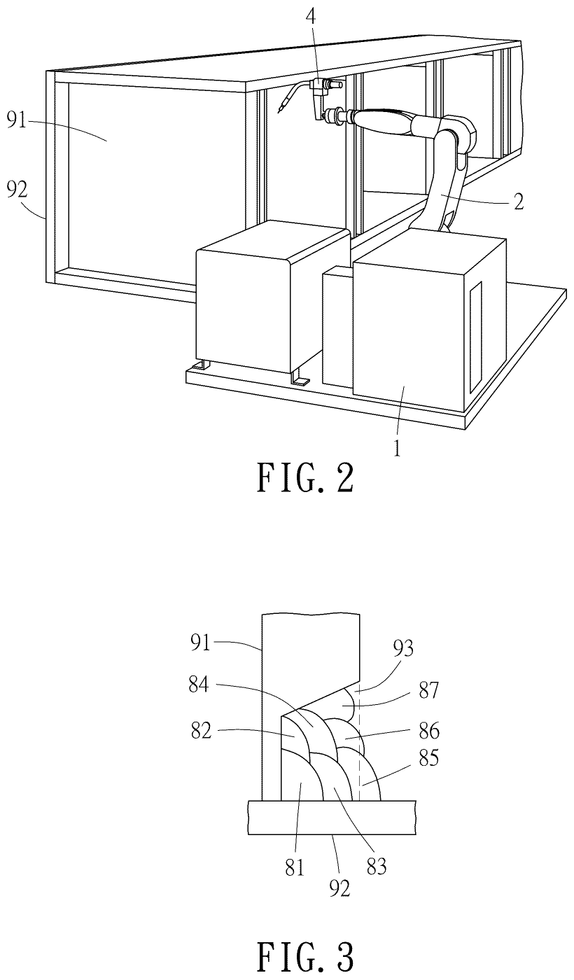

Referring to FIGS. 1 and 2, an embodiment of an intelligent automated multi-pass welding method is adapted to a system that is used to perform welding on two steel components 91, 92 and that includes a computerized control device 1, a robotic arm 2, an optical measuring instrument 3, a welding device 4 (e.g., a metal inert gas (MIG) welder, a tungsten inert gas (TIG) welder, a stick welder, a multiprocess welder, etc.), a slag removal device 5 (e.g., a wire brush, an angle grinder, a needle scaler, etc.), a welding wire feeder 6, and a welding parameter sensor instrument 7. The robotic arm 2 may be, for example, a six-axis robotic arm configured to selectively operate the optical measuring instrument 3 to perform optical measurement, operate the welding device 4 to perform welding, or operate the slag removal device 5 to perform removal of slag, and is further configured to record a welding path, a welding angle, and a moving speed of the robotic arm 2. The optical measuring instrument 3 may be, for example, a laser scanner, a depth camera, a LiDAR, etc. The slag removal device 5 is configured to remove or clear slag from a welding space and/or weld pass(es). The welding parameter sensor instrument 7 may include, for example, a voltage detector, a current detector, a wire feeding speed meter, other suitable devices, or any combination thereof.

FIG. 2 exemplifies a welding work on a steel diaphragm within a box-shaped steel column. In other words, the steel diaphragm and the box-shaped steel column are examples of the steel components 91, 92 in FIG. 2. It is noted that FIG. 2 only illustratively shows relative positions of the steel components 91, 92, the computerized control device 1, the robotic arm 2, and the welding device 4, and does not explicitly illustrate positions of the optical measuring instrument 3, the slag removal device 5, the welding wire feeder 6 and the welding parameter sensor instrument 7. FIG. 3 illustrates a fragmentary sectional view of the steel components 91, 92 that are in contact with each other. If the first to seventh weld passes 81 to 87 are ignored, it may be observed that, before welding is performed, a joint or a contact area between the steel components 91, 92 forms a welding space 93, which is defined by the steel components 91, 92, and an imaginary plane extending downward from a right surface of the steel component 91 to the steel component 92.

The computerized control device 1 may include, for example, an industrial computer and a robotic arm control equipment, is electrically connected to the robotic arm 2, the welding wire feeder 6, and the welding parameter sensor instrument 7, and stores a first artificial intelligence (AI) model and a second AI model. In this embodiment, the first AI model is built using a reinforcement learning (RL) algorithm within a machine learning framework, and is a regression model trained using a recurrent neural network (RNN) in a simulated environment with reinforcement learning. The second AI model belongs to a classification model of the recurrent neural network within the machine learning framework

Each of the first AI model and the second AI model is trained using a plurality of training datasets. Each of the training datasets corresponds to a reference welding space (with or without a weld pass or weld passes formed therein), and includes known information such as a pre-welding (i.e., before forming a target weld pass) geometry information record (e.g., a three-dimensional model in a three-dimensional coordinate system) and a post-welding (i.e., after forming the target weld pass) geometry information record of the reference welding space, multiple welding control parameters set for the welding device 4 (e.g., a target current record, a target voltage record, etc.), multiple measured welding parameters (e.g., a measured current record and a measured voltage record that respectively correspond to the target current record set for the welding device 4, etc.), multiple robotic arm control parameters set for the robotic arm 2 (e.g., a welding path record, a welding angle record, a moving speed record, etc.), multiple measured robotic arm parameters (e.g., a measured welding path record, a measured welding angle record and a measured moving speed record that respectively corresponds to the welding path record, the welding angle record and the moving speed record set for the robotic arm 2, etc.), a feeder control parameter (e.g., a wire feeding speed record set for the welding wire feeder 6, etc.), and a measured feeder parameter (e.g. a measured wire feeding speed record that corresponds to the wire feeding speed record set for the welding wire feeder 6). In some embodiments, some of the abovementioned parameters may be omitted from the training datasets. In some embodiments, additional control parameters and measured parameters may be included in the training datasets.

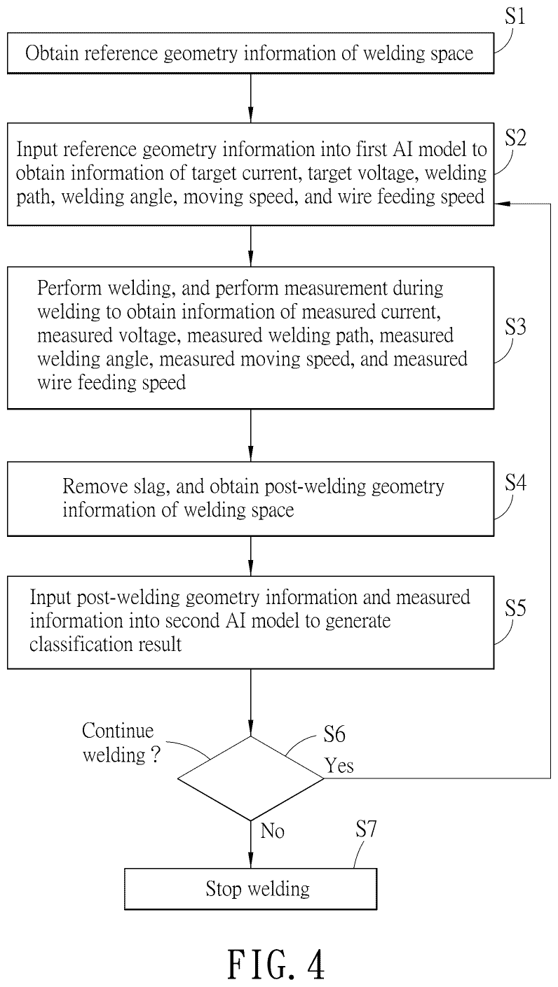

Referring to FIG. 4, the embodiment of the intelligent automated multi-pass welding method includes steps S1 to S7.

In step S1, the computerized control device 1 controls the robotic arm 2 to select the optical measuring instrument 3 to measure the welding space 93, thereby obtaining reference geometry information of the welding space 93. As exemplified in FIG. 3, a ready to be used welding space 93 can be identified by omitting the first to seventh weld passes 81 to 87, and the reference geometry information of the welding space 93 may be deemed as a three-dimensional model in a three-dimensional coordinate system. For example, the reference geometry information of the welding space 93 may be a three-dimensional point cloud dataset that is obtained by scanning along the welding space 93 and that is recorded as multiple planar 2D points, with each plane oriented perpendicular to an extending direction of the welding space 93. Through the reference geometry information of the welding space 93, the computerized control device 1 can identify assembly errors between the steel components 91, 92, a position of the welding space 93, and a space to be filled with weld passes, etc. In some embodiments, the optical measuring instrument 3 may be installed on a preset track, and the computerized control device 1 controls a driver device that may include, for example, a motor, a gear set, a load stage, etc., to drive movement of the optical measuring device 3 along the preset track.

In step S2, the computerized control device 1 receives the reference geometry information of the welding space 93 from the optical measuring instrument 3, and inputs the reference geometry information of the welding space 93 into the first AI model, thereby obtaining information of a target current and a target voltage of the welding device 4, the welding path, the welding angle and the moving speed of the robotic arm 2, and a wire feeding speed of the welding wire feeder 6. In some embodiments, the first AI model may not output information of the wire feeding speed, and the welding wire feeder 6 is controlled by the computerized control device 1 to feed the welding wire at a preset wire feeding speed.

In step S3, the computerized control device 1 sends the information of the target current and the target voltage to the welding device 4 for the welding device 4 to use the target current and the target voltage as operation settings thereof, and sends the information of the wire feeding speed to the welding wire feeder 6 for the welding wire feeder 6 to use the wire feeding speed as an operation setting thereof. Then, the computerized control device 1 selects the welding device 4 to work with the welding wire feeder 6 to perform welding on the welding space 93 according to the welding path, the welding angle and the moving speed, thereby forming a weld pass (e.g., the first weld pass 81 in FIG. 3) in the welding space 93. The welding path includes a starting point of the weld pass, multiple key turning points, and an endpoint of the weld pass. Each of the key turning points represents a non-linear bend of the weld pass, or a turnaround of the robotic arm 2. During the welding of the weld pass, the welding parameter sensor instrument 7 and the robotic arm 2 perform measurements with respect to the abovementioned control parameters, and the computerized control device 1 receives, from the welding parameter sensor instrument 7, information of a measured current and a measured voltage of the welding device 4, and a measured wire feeding speed of the welding wire feeder 6, and receives, from the robotic arm 2, information of a measured welding path, a measured welding angle, and a measured moving speed of the robotic arm 2. The measured voltage and the measured current are obtained by the welding parameter sensor instrument 7 at a position of a welding wire that is used for welding, and the position may be near a molten area of the welding wire. The measured moving speed corresponds to a speed of a welding wire clamp at a front end of the robotic arm 2, while the measured wire feeding speed corresponds to an output speed of the welding wire at the welding wire clamp. In some embodiments, a robotic arm or a robot that has fewer degrees of freedom may be installed on another preset track to be used as the robotic arm 2, as long as the welding can be performed according to the welding path, the welding angle and the moving speed.

After the weld pass (e.g., the first weld pass 81) is formed, in step S4, the computerized control device 1 controls the robotic arm 2 to select the slag removal device 5 to remove slag based on the reference geometry information of the welding space 93, and then controls the robotic arm 2 to operate the optical measuring instrument 3 to measure the welding space 93 after the removal of slag, thereby obtaining post-welding geometry information of the welding space 93, which may be a three-dimensional model of the welding space 93 in which the first weld pass 81 has been formed in the three-dimensional coordinate system. In some embodiments, the removal of slag is not performed after a weld pass is formed, and the slag removal device 5 may be omitted.

In step S5, the computerized control device 1 receives the post-welding geometry information of the welding space 93 from the optical measuring instrument 3, and inputs the post-welding geometry information of the welding space 93 and information measured during the welding in step S3 (including but not limited to, the measured current and the measured voltage of the welding device 4, the measured welding path, the measured welding angle and the measured moving speed of the robotic arm 2, the wire feeding speed of the welding wire feeder 6, etc.) into the second AI model, thereby obtaining a classification result. The classification result may indicate a controllable quality with an incomplete welding state, an uncontrollable quality state, or a welding completed state. In some embodiments, the second AI model may be omitted, and the computerized control device 1 performs image recognition based on the post-welding geometry information of the welding space 93 to generate the classification result. In this scenario, the welding parameter sensor instrument 7 may be omitted.

In step S6, the computerized control device 1 determines, based on the classification result, whether to continue welding. In detail, in response to the classification result indicating the controllable quality with an incomplete welding state, which means that no welding flaws (e.g., pores, overflows, etc.) or only acceptable flaws (i.e., flaws that fall within a predetermined range) are present in the welding space 93, and that the welding space 93 has not been filled yet, the computerized control device 1 determines to form a next weld pass in the welding space 93 (e.g., the second weld pass 82), and makes the post-welding geometry information of the welding space 93 serve as the reference geometry information of the welding space 93 for use in step S2 in the next welding. Then, the flow goes back to step S2. Steps S2 to S6 are repeatedly performed until the computerized control device 1 determines to stop welding. As an example, the second to seventh weld passes 82 to 87 in FIG. 3 are formed during the repetitions of steps S2 to S7. The computerized control device 1 determines to stop welding in response to the classification result indicating the uncontrollable quality state or the welding completed state.

In step S7, the computerized control device 1 stops welding, and terminates the welding process.

In summary, the embodiment according to this disclosure uses the optical measuring instrument 3 to obtain the geometry information of the welding space 93, and then the geometry information is inputted into the first AI model to obtain the control parameters used by the welding device 4 and the welding wire feeder 6 as the operation settings to perform welding. Then, the welding parameter sensor instrument 7 is used to obtain the measured parameters for the second AI model to generate the classification result, enabling the computerized control device 1 to determine whether to continue welding. As a result, the intelligent automated multi-pass welding is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An automated multi-pass welding method, comprising steps of:
A) by an optical measuring instrument, measuring a welding space formed by two steel components that is in contact with each other, thereby obtaining reference geometry information of the welding space;
B) by a computerized control device, inputting the reference geometry information of the welding space into a first artificial intelligence (AI) model, thereby obtaining control parameters of a welding device and a robotic arm, where the welding device is to be used for welding, and the robotic arm is used to operate the welding device;
C) by the welding device and the robotic arm, using the control parameters as operation settings thereof to cause the welding device to work with a welding wire feeder to perform welding on the welding space, thereby forming a weld pass in the welding space;
D) by the optical measuring instrument, measuring the welding space after the weld pass is formed in the welding space, thereby obtaining a post-welding geometry information of the welding space;
E) by the computerized control device, generating a classification result based on the post-welding geometry information of the welding space; and
F) by the computerized control device, upon determining, based on the classification result, to form a next weld pass in the welding space, repeating steps B) to F) with the post-welding geometry information of the welding space serving as the reference geometry information of the welding space, until the computerized control device determines to stop welding based on the classification result.

2. The automated multi-pass welding method as claimed in claim 1, wherein, in step E), the classification result indicates one of a controllable quality with an incomplete welding state, an uncontrollable quality state, and a welding completed state;
wherein, in step F), in response to the classification result indicating the controllable quality with an incomplete welding state, the computerized control device determines to form the next weld pass in the welding space; and
wherein, in response to the classification result indicating one of the uncontrollable quality state and the welding completed state, the computerized control device determines to stop welding.

3. The automated multi-pass welding method as claimed in claim 1, further comprising a step of: by a welding parameter sensor instrument and the robotic arm, performing measurement during the welding of the weld pass in step C), thereby obtaining a plurality of measured parameters that correspond to the control parameters, respectively; and
wherein, in step E), the computerized control device inputs the measured parameters and the post-welding geometry information of the welding space into a second AI model, thereby obtaining the classification result.

4. The automated multi-pass welding method as claimed in claim 1, wherein, in step B), the control parameters obtained by inputting the reference geometry information of the welding space into the first AI model further include an additional parameter corresponding to the welding wire feeder;
wherein the control parameters include a target current and a target voltage of the welding device, a welding path, a welding angle and a moving speed of the robotic arm, and a wire feeding speed of the welding wire feeder;
wherein, in step C), the welding wire feeder uses the wire feeding speed included in the control parameters as an operation setting thereof to work with the welding device to perform welding on the welding space;
wherein the measured parameters include a measured current corresponding to the target current included in the control parameters, a measured voltage corresponding to the target voltage included in the control parameters, a measured welding path corresponding to the welding path included in the control parameters, a measured welding angle corresponding to the welding angle included in the control parameters, a measured moving speed corresponding to the moving speed included in the control parameters, and a measured wire feeding speed corresponding to the wire feeding speed included in the control parameters.

5. The automated multi-pass welding method as claimed in claim 4, wherein the first AI model is built using a reinforcement learning algorithm within a machine learning framework, and is based on a regression model of a recurrent neural network;
wherein the second AI model belongs to a classification model of the recurrent neural network within the machine learning framework;
wherein each of the first AI model and the second AI model is trained using a plurality of training datasets each including:
a target current record and a target voltage record set for the welding device,
a measured current record and a measured voltage record that respectively correspond to the target current record and the target voltage record set for the welding device,
a welding path record, a welding angle record and a moving speed record set for the robotic arm,
a measured welding path record, a measured welding angle record and a measure moving speed record that respectively corresponds to the welding path record, the welding angle record and the moving speed record set for the robotic arm,
a wire feeding speed record set for the welding wire feeder,
a measured wire feeding speed record that corresponds to the wire feeding speed record set for the welding wire feeder, and
a pre-welding geometry information record and a post-welding geometry information record of the welding space.

6. The automated multi-pass welding method as claimed in claim 1, further comprising, after the weld pass is formed in step C) and before the welding space is measured in step D), a step of: by a slag removal device, removing slag from the welding space based on the reference geometry information of the welding space.

7. The automated multi-pass welding method as claimed in claim 6, wherein movement of the welding device and movement of the slag removal device are carried out by the computerized control device operating the robotic arm; and
wherein the optical measuring instrument is moved by the computerized control device through operating the robotic arm, or is controlled by the computerized control device to move along a preset track.

8. The automated multi-pass welding method as claimed in claim 1, wherein the optical measuring instrument includes one of a depth camera, a laser scanner, and a LiDAR.
